(19) United States
(12) Patent Application Publication
(10) Pub. No.: US 2022/0402128 A1
(43) Pub. Date: Dec. 22, 2022

(54) TASK-ORIENTED GRASPING OF OBJECTS

(71) Applicant: Intrinsic Innovation LLC, Mountain View, CA (US)

(72) Inventors: Wenzhao Lian, Fremont, CA (US); Stefan Schaal, Mountain View, CA (US); Bowen Wen, Edison, NJ (US)

(21) Appl. No.: 17/845,748

(22) Filed: Jun. 21, 2022

Related U.S. Application Data
(60) Provisional application No. 63/212,493, filed on Jun. 18, 2021.

(51) Int. Cl. B25J 9/16

(52) U.S. Cl. CPC B25J 9/1612; B25J 9/1671; B25J 9/1661

(57) ABSTRACT

A computer-implemented method includes obtaining a collection of object models for a plurality of different types of objects belonging to a same object category, generating a canonical representation for objects belonging to the object category, performing a plurality of downstream tasks using a plurality of different robot grasps on instances of objects belonging to the category and evaluating each grasp according to success or failure of the downstream task; and generating one or more category-level grasping areas for the canonical representation for objects belonging to the object category including aggregating the evaluations of grasps according to the downstream task.

### CROSS-REFERENCE TO RELATED APPLICATION

This application claims priority to U.S. Patent Application No. 63/212,493, filed on Jun. 18, 2021, entitled, “Learning Category-Level Task-Oriented Grasping of Industrial Objects in Dense Clutter from Simulation,” which is herein incorporated by reference.

### BACKGROUND

This specification relates to robotics, and more particularly to planning robotic movements.

Robotic manipulation refers to controlling the physical movements of robots in order to perform tasks. Robotic manipulation tasks require a robotic component, e.g., an end effector, to physically contact an object to effectuate some change in the object. For example, an industrial robot that builds cars can be programmed to first pick up a car part and then weld the car part onto the frame of the car.

Robotic manipulation often requires a suitable grasp equipped with semantic meaning aligned with the downstream task. An important application domain is industrial assembly, where the robot needs to perform constrained placement after grasping the objects. In such cases, a suitable grasp requires stability during object grasping and transporting, meanwhile avoiding obstructing the placement process. For instance, a grasp where the gripper fingers covering the thread portion of a screw can impede its placement through a hole, is not a task-oriented semantic grasp.

However, solving task-oriented semantic grasping is a challenging problem, as the grasp and task performances are co-defining and conditional on each other. In addition, task-oriented grasping involves high-level semantic information which is difficult to model analytically. Current techniques using deep learning are limited in at least two ways.

First, annotations on 3D models are significantly more challenging than 2D image alternatives, as the annotator needs to operate over multiple views of the 3D model to complete the labeling process. Second, because training supervision solely comes from pixel-wise segmentation or pre-defined keypoints, there lacks explicit capture of the cross-object instance information. Therefore, generalizing to novel objects remains a challenge, specifically with capturing the category-level priors related to task-oriented grasping through end-to-end training. While the environment constraints on grasps are significantly more complex, the solution space is much larger and introduces much more computational complexity.

### SUMMARY

This specification describes techniques for learning category-level, task-relevant grasping for robotic manipulation tasks.

After training, the model can be directly applied to novel object instances with previously unseen dimensions and shape variations, saving the effort of acquiring 3D models or re-training for each individual instance. The system can generate a canonical representation shared across diverse instances within the object category. Once trained, this category-level, task-relevant grasping knowledge transfers across novel instances, and also effectively generalizes to real-world densely cluttered scenarios without the need for fine-tuning. In addition, the training process can be performed entirely in simulation.

This system can include a framework for learning category-level, task-relevant, grasping of objects and targeted placement; at least one virtual simulation for developing canonical object representations for multiple object categories; at least one 3D shape modeled with dense, point-wise task relevance; and at least one coordinate space for learning category-level object 6D poses and 3D scaling.

The framework can generalize to the real-world without any re-training by leveraging domain randomization, bi-directional alignment, and domain-invariant, hand-object contact heatmaps, representing suitable grasping areas, modeled in a category-level canonical space. This dense 3D representation eliminates the requirement of manually specifying keypoints, which is time intensive and prone to human error. This virtual simulation can be a Non-Uniform Normalized Object Coordinate Space (NUNOCS) representation for learning category-level object 6D poses and 3D scaling, which allows for non-uniform scaling across three dimensions. This virtual representation establishes reliable dense correspondence and enables fine-grained knowledge transfer across object instances with large shape variations. Given one or more instance models, all points in the canonical virtual simulation are normalized along each dimension to reside within a unit cube.

In addition to being used for synthetic training data generation, the instance models can also be used to create a category-level canonical template model, a grasping area heatmap, and a stable grasp codebook. To do so, each model can be converted to a given space, and the canonical template model is represented by the minimum sum of chamfer distances to all other models. The transformation from each model to this template can then be utilized for aggregating the stable grasp codebook and the task-relevant grasping area heatmap. The learning task can be formulated as a classification problem by discretizing space density into bins. Along with the predicted dense correspondence, the 9D object pose can be also recovered to provide an affine transformation from the predicted canonical space cloud to the observed object segment cloud, while ensuring the rotation component to be orthonormal.

During offline training, grasp poses can be uniformly sampled from the point cloud of each object instance, covering the feasible grasp space around the object. For each grasp, the grasp quality can be evaluated in simulation. To compute a continuous score as training labels, multiple neighboring grasp poses, for example 50, are randomly sampled in the proximity and executed to compute the empirical grasp success rate. Once the grasps are generated, they can then be exploited in two ways:

First, given the relative 9D transformation from the current instance to the canonical model, the grasp poses can be converted into the virtual simulation space and stored in a stable grasp codebook. During testing, given the estimated 9D object pose of the observed object's segment relative to the canonical space, grasp proposals can be generated by applying the same transformation to the grasps in the set. Compared with traditional online grasp sampling over the raw point cloud, this grasp knowledge transfer is also able to generate grasps from occluded object regions. The two strategies can be combined to form a robust hybrid mode for grasp proposal generation.

Second, the generated grasps can be utilized for training the grasping network, which can be a Grasping Q Net, which is built based on external software. In each dense clutter generated, the object segment in the 3D point cloud is transformed to the grasp's local frame given the object and grasp pose. The grasping network can take the point cloud as input and predict the grasp's quality, which can then be compared against the discretized grasp score, e.g., to compute cross entropy loss.

This system is designed to discover grasp affordance via self-interaction. In particular, the objective is to compute a probabilistic function that describes the relative merit of different grasping positions not only for a successful grasp but also the subsequent completion of a task. This probabilistic function can take the form of the equation below:

P(T|G)=P(T,G)/P(G)

Where P(G) is the probability of a successful grasp and P(T,G) is the probability of a successful grasp followed by successful task completion.

To achieve these results, a dense 3D point-wise grasping area heatmap can be modeled. For each grasp in the codebook, a grasping process can first be simulated. The hand-object contact points can be identified by computing their signed distance with respect to the gripper mesh. If the grasp is stable, for example the object is lifted successfully against gravity, the count n(G) for all contacted points on the object can be increased by 1. Otherwise, the grasp can be skipped. For such stable grasps, a placement process can be simulated, for example placing the grasped object on a receptacle, to verify the task relevance. Collisions can be checked between the manipulator and the receptacle during this process. If the manipulator does not obstruct the placement, and if the object can steadily rest in the receptacle, the count of joint grasp and task success n(G,T) on the contact points can be increased by 1. After all grasps are verified, for each point on the object point cloud, its task relevance can be computed according to:

P(T|G)=n(G,T)/n(G)

Eventually, for each of the training objects within the category, the hand-object contact heatmap P(T|G) is transformed to the canonical model. The task-relevant heatmaps over all training instances are aggregated and averaged to be the final canonical model's task-relevance heatmap. During testing, due to the partial view of the object's segment, the antipodal contact points are identified between the system and the transformed canonical model. For each grasp candidate, the score P_{G}(T|G) is computed and combined with the predicted P_{G}(G) from the grasping network to compute the grasp's task-relevance score P_{G}(T,G). The highest task-relevance score indicates the best grasp for the object for the given task.

Particular embodiments of the subject matter described in this specification can be implemented so as to realize one or more of the following advantages. The techniques described in this specification allow a robotic control system to learn truly generalizable category-level grasping areas that apply to all objects belonging to the category.

The category-level grasping areas can be learned without human annotations from digital object models, e.g., CAD models, without requiring any real-world data collection in a workcell. Instead, massive amounts of training data can be collected by simply crawling publicly available sources, e.g., the Internet.

In addition, the grasping areas are task-specific, meaning that they are optimized for performing a particular downstream task. For example, while holding a nut by inserting an end effector in the hole of the nut might provide a secure grasp generally, a downstream task of attaching the nut to a bolt is sure to fail if the hole is obstructed. Using the techniques described in this specification will cause the system to automatically learn that all instances in the category of nuts should be grasped on the sides and not in the hole for fastener tasks that require attaching the nut to a corresponding bolt. And the system can automatically learn different grasps for different tasks. Thus, if the task is simply picking up a nut and placing it into a receptacle, the system might automatically learn that a grasp that uses the hole is best.

The category-level grasping areas generalize to many other types of objects in the same category. This means that the grasping tasks can be performed on new objects that have never been seen by the system.

In addition, grasping can be performed on a new object without any adjustments or adaptations. In other words, the downstream task can be performed on a new object in the category without adjusting the model, without collecting additional data, without collecting human annotations, and without retraining.

In addition, the techniques described below are far more robust than reinforcement based learning approaches. Furthermore, the techniques described below are particularly well-suited for contact-rich tasks in which parts of the downstream task are intended to make contact. Such contact-rich tasks are difficult to learn for reinforcement learning systems.

The details of one or more embodiments of the subject matter of this specification are set forth in the accompanying drawings and the description below. Other features, aspects, and advantages of the subject matter will become apparent from the description, the drawings, and the claims.

### BRIEF DESRIPTION OF THE DRAWINGS

FIG. 1 is a diagram of an example system and method.

FIG. 2 is an example system framework.

FIGS. 3A, 3B, and 3C each illustrate an example of a task-relevant object can be handled by the system.

FIG. 4 is a flowchart of an example process for learning grasping areas for a canonical representation of objects belonging to a same object category.

Like reference numbers and designations in the various drawings indicate like elements.

### DETAILED DESCRIPTION

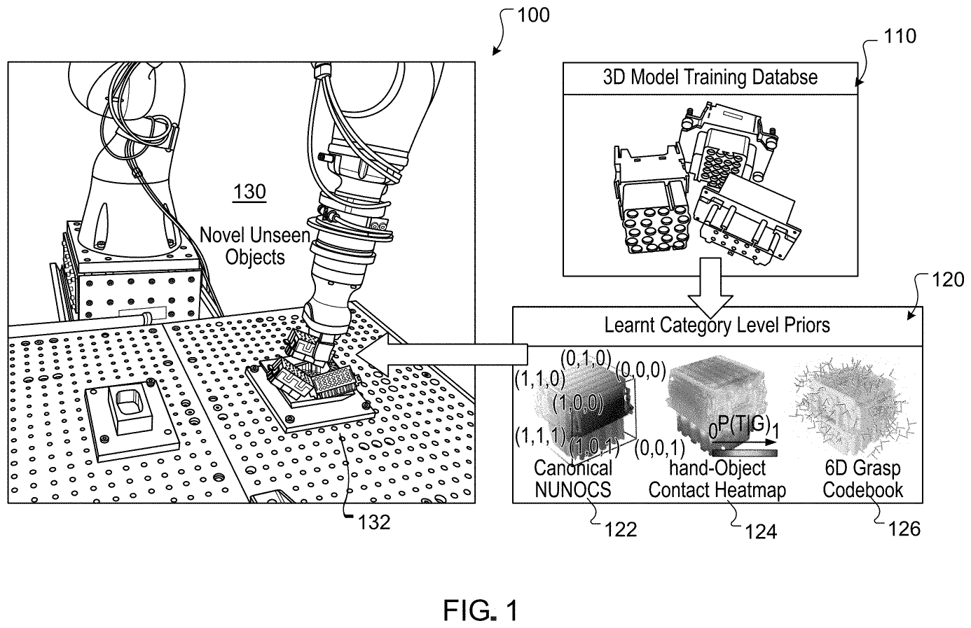

FIG. 1 illustrates an example system 100. This system 100 can include major functional areas to include 3D model simulation training 110, learnt grasping information 120, and the workspace 130 which includes at least one object 132 which can be assigned to an object category. An object category is defined as a generic object form to which multiple objects may share similar characteristics. For example, an object category of ‘screw’ may cover all narrow cylindrical objects with a wide head structure above a more narrow thread. In this instance a screw of any size, material, length, thread size or shape, or other determined properties may fit in this object category. The same example could apply to a nut, washer, fastener, electronic connector, pipe, flange, panel, or any other object that can be said to have features that are similar to a holistic group of objects. 3D model simulation training 110 with the select object category is used to generate data that informs the grasping information 120. Learnt grasping information 120 can include information from multiple sources, to include multiple canonical object category representations 122, multiple grasping area heatmaps 124, and a 6D grasp codebook 126. A canonical object category representation 122 is a spatial representation of the object category to which new objects 132 are compared for the purpose of grasping. The data from these various methods is combined and ranked, with the ideal grasp of object 132 passed to the workspace 130.

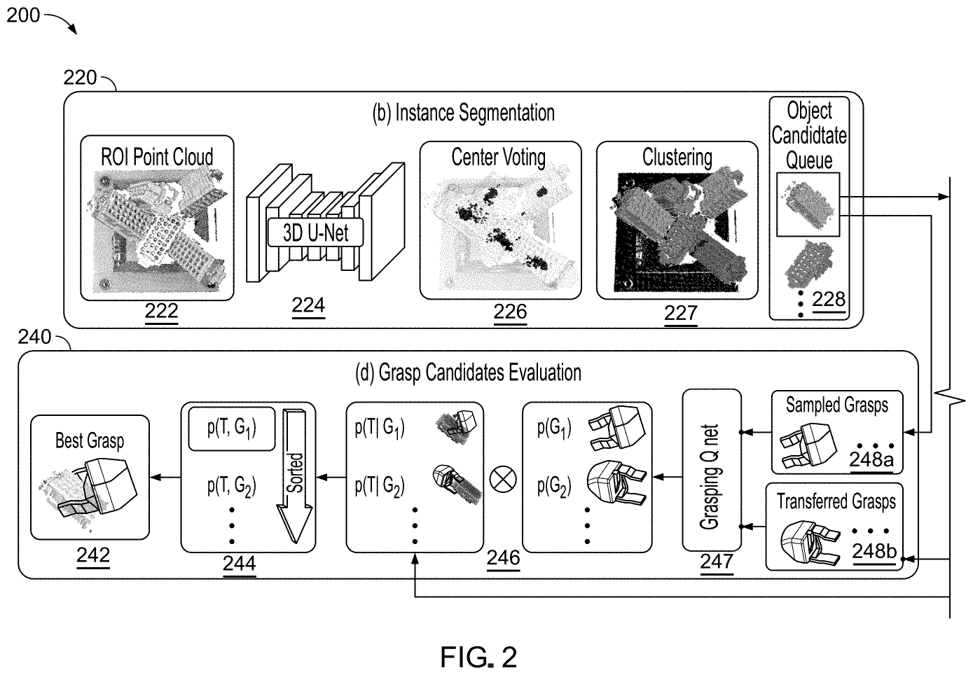

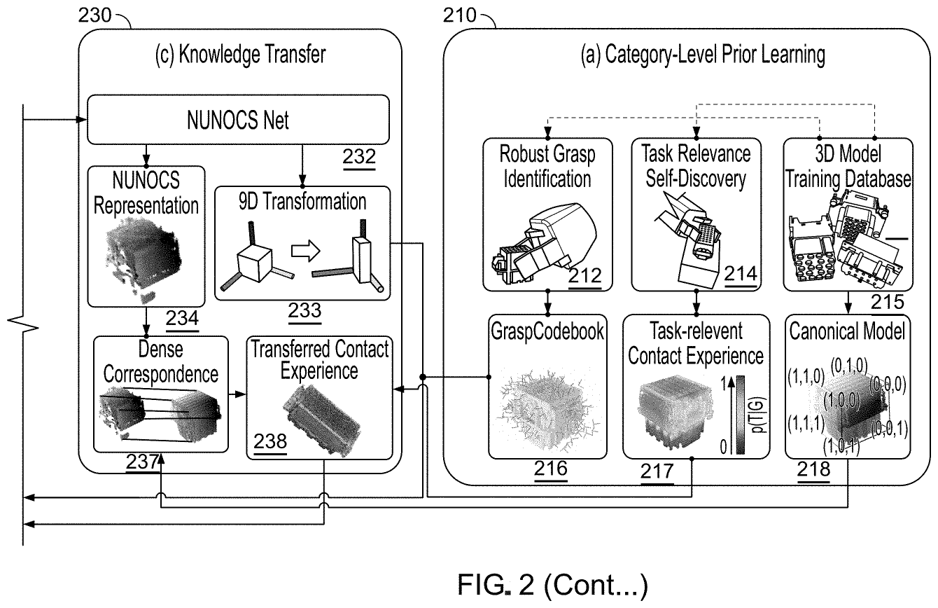

FIG. 2 illustrates an example framework 200. The framework 200 can include different functional subsystems that include category level prior learning 210, instance segmentation 220, knowledge transfer 230, and grasp candidates evaluation 240. These subsystems can be implemented by a system of one or more computers in one or more locations.

The category level prior learning 210 functional subsystem can include different subprocesses to include robust grasp identification 212, task-relevance self-discovery 214, multiple CAD models 215, multiple grasp codebooks 216, task-relevant contact experience 217, and multiple canonical models 218. Given a collection of CAD models 215 for objects of the same category, the data is aggregated to generate a canonical model 218 for the category. This CAD data 215 is also used to inform robust grasp identification 212 and task-relevance self-discovery 214. The multiple CAD models 215 can be supplied by the user or made available to the system from public information, to include the Internet. The CAD models 215 are further utilized in virtual simulation 232 to generate synthetic point cloud data for training in multiple point cloud 222 and 3D networks 224. The virtual simulation 232 can be a Non-Uniform Normalized Object Coordinate Space (NUNOCS). The category-level grasp codebooks 216, created from robust grasp identification 212, and task-relevant contact experience 217, created from task-relevance self-discovery 214, are identified via self-interaction in virtual simulation 232.

The instance segmentation 220 functional subsystem can include different subprocesses to include one or more point clouds 222, one or more 3D networks 224, center voting 226, clustering 227, and an object candidate queue 228. The point cloud 222 is a spatial representation of the grasping area together with the objects, where many possible discrete grasping locations are assigned without regard to individual objects. The 3D network 224 is leveraged to predict point-wise centers of discrete objects in the point cloud 222 through center voting 226. Clustering 227 is then used to separate this gross collection of points into collections that correspond to different objects. The object candidate queue 228 is then used to inform the virtual simulation 232 and sampled grasps 248a of the original object environment.

The knowledge transfer 230 functional subsystem can include different subprocesses to include a virtual simulation 232, a visual representation of said virtual simulation 234, a 9D pose estimation transformation of said virtual simulation 233, a dense correspondence method of transformation 237, and transferred contact experience 238. The virtual simulation 232 operates over an object's segmented point cloud 222 and predicts its representation 234 of the object to establish dense correspondence 237 with the canonical models 218 and compute its 9D pose 236, which represents the degree of departure from the canonical model 218. The associated precomputed category-level contact experience 238 for the object category and canonical model 218 is then transferred to the task-relevance score equation 246.

The grasp candidates evaluation 240 functional subsystem can include different subprocesses to include sample grasps 248a and transferred grasps 248b, a grasping network 247, a task-relevance score equation 246, sorting of task-relevance scores 244, and the determined best grasp 242. Grasp proposals are generated by both directly sampled grasps 248a chosen through center voting 226 over the 3D network 224, and transferred grasps 248b from a grasp codebook 216. Infeasible or in-collision grasps are rejected by a grasping network 247. The grasping network 247 evaluates the stability of the accepted grasp proposals 248a and 248b. This information is combined with a task-relevance score computed from the grasp's contact region through a probabilistic task-relevant score equation 246. The entire process can be repeated for multiple object segments. The task-relevant score equation 246 is given by the below:

P(T|G)=P(T,G)/P(G)

Where P(G) is the probability of a successful grasp and P(T,G) is the probability of a successful grasp followed by successful task completion. The results of the task-relevance score equation 246 are sorted 244 and the best grasp 242 is determined and passed to the system 100.

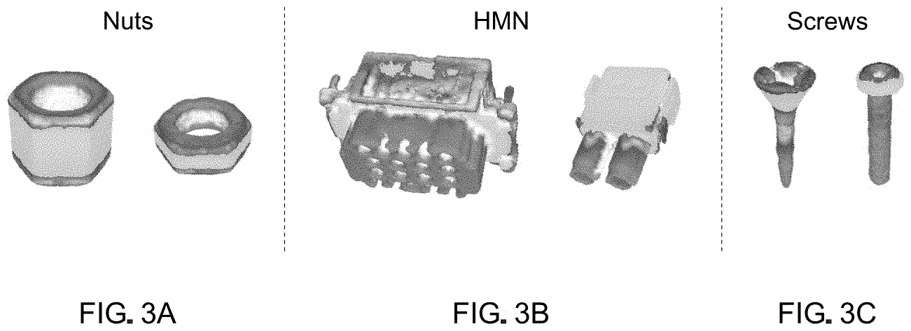

FIG. 3 illustrates task-specific heatmaps for example industrial objects. The industrial objects could be of any suitable size, shape, or material. These industrial objects can include nuts (FIG. 3A), electronic connectors (FIG. 3B), or screws (FIG. 3C).

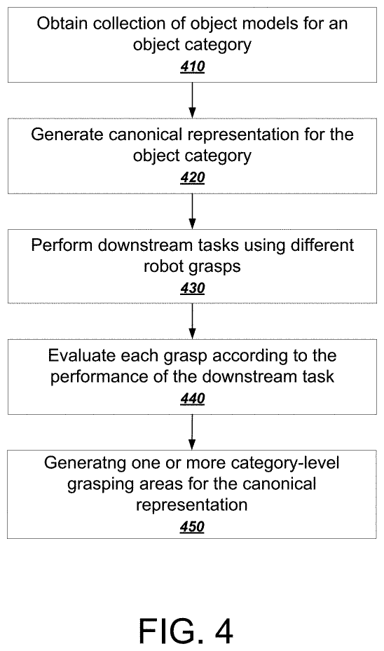

FIG. 4 is a flowchart of an example process for learning grasping areas for a canonical representation of objects belonging to a same object category. The example process can be performed by a system of one or more computers programmed in accordance with this specification, e.g., a distributed computer system that implements the framework illustrated and described with respect to FIG. 2. The example process will be described as being performed by a system of one or more computers.

The system obtains a collection of object models for an object category (410). To begin the process of modeling grasping positions for object categories, CAD models of the objects are obtained. These models can either be provided by the user or loaded from publically available data, e.g., the Internet. There is no requirement for format, provided that there is enough fidelity to assign discrete points to the object.

For example, it is assumed that a collection of 3D models MC belonging to category C for training have been uploaded. This does not include any testing instance in the same category, i.e., M_{C}^{test}∉MC. Offline, given a collection of models MC of the same category, synthetic data can be generated in simulation. Then, self-interaction in simulation provides hand-object contact experience, which is summarized in task-relevant grasping area heatmaps for grasping.

The system generates a canonical representation for the object category (420). In other words, the system can develop a canonical object representation that can be extended to include the object described in the provided CAD models. For example, the canonical NUNOCS representation allows the aggregation of category-level, task-relevant knowledge across instances. Online, the category-level knowledge is transferred from the canonical NUNOCS model to the segmented target object via dense correspondence and 9D pose estimation, guiding the grasp candidate generation and selection. Dense correspondence is established in 3D space to transfer knowledge from a trained model database MC to a novel instance M_{C}^{test}. For example, given an instance model M, all the points can be normalized along each dimension, to reside within a unit cube:

p_{C}^{d}=(p^{d}−pₘᵢₙ^{d})/(pₘₐₓ^{d}−pₘᵢₙ^{d})∈[0,1]; d∈{x,y,z}

The transformed points exist in the canonical NUNOCS C. In addition to being used for synthetic training data generation the models MC are also used to create a category-level canonical template model, to generate a grasping area heatmap and a stable grasp codebook. To do so, each model in MC is converted to the space C, and the canonical template model is represented by the one with the minimum sum of Chamfer distances to all other models in MC. The transformation from each model to this template is then utilized for aggregating the stable grasp codebook and the task-relevant grasping area heatmap.

For example, in the NUNOCS Net, the relation Φ: Po→PC is determined, where Po and PC are the observed object cloud and the canonical space cloud, respectively. Φ(.) is built with a PointNet-like architecture given it is light-weight and efficient. The learning task is formulated as a classification problem by discretizing pdC into a certain number of bins, for example 100. Softmax cross entropy loss is used as we found it more effective than regression by reducing the solution space. Along with the predicted dense correspondence the 9D object pose is also recovered, given below:

ξ₀∈{SE(3)×R³}

The 9D object pose is computed, for example, via RANSAC to provide an affine transformation from the predicted canonical space cloud PC to the observed object segment cloud Po, while ensuring the rotation component to be orthonormal.

The system performs downstream tasks using different robot grasps (430). The system can perform grasping trials using predetermined grasping locations. For example, during offline training, grasp poses can be uniformly sampled from a point cloud of each object instance, covering the feasible grasp space around the object. For each grasp G, the grasp quality can be evaluated in simulation. For example, to compute a continuous score:

s_{G}∈[0,1]

50 neighboring grasp poses can be randomly sampled in the proximity of:

ξ_{G}∈SE(3)

and executed to compute the empirical grasp success rate.

The system evaluates each grasp according to the performance of the downstream task (440). The probability of a successful grasp and of successful task completion can be captured for each position 440. Once the grasps are generated, they are then exploited in two ways.

First, for example, given the relative 9D transformation from the current instance to the canonical model, the grasp poses are converted into the NUNOCS space and stored in a stable grasp codebook G. During test time, given the estimated 9D object pose of the observed object's segment relative to the canonical space C, grasp proposals can be generated by applying the same transformation to the grasps in G. Compared with traditional online grasp sampling over the raw point cloud, this grasp knowledge transfer is also able to generate grasps from occluded object regions. In practice, the two strategies can be combined to form a robust hybrid mode for grasp proposal generation.

Second, for example, the generated grasps are utilized for training the Grasping Q Net, which is built based on PointNet. Specifically, in each dense clutter generated, the object segment in the 3D point cloud is transformed to the grasp's local frame given the object and grasp pose. The Grasping Q Net takes the point cloud as input and predicts the grasp's quality P(G), which is then compared against the discretized grasp score sG to compute softmax cross entropy loss.

The total probability of successful task completion following a successful grasp is then calculated for each position and the results and ranked by probability 450. For example, the objective is to compute P(T|G)=P(T,G)/P(G) automatically for all graspable regions on the object. To achieve this, a dense 3D point-wise grasping area heatmap is modeled. For each grasp in the codebook, a grasping process is first simulated. The hand-object contact points are identified by computing their signed distance with respect to the gripper mesh. If it is a stable grasp, for example the object is lifted successfully against gravity, the count n(G) for all contacted points on the object are increased by a fixed interval, for example, one. In this specification, a grasp being stable, or equivalently, grasping areas being stable, means that an object was successfully lifted using one or more grasping areas. Otherwise, the grasp is skipped. For these stable grasps, a placement process is simulated, for example placing the grasped object on a receptacle, to verify the task relevance. Collision is checked between the gripper and the receptacle during this process. If the gripper does not obstruct the placement and if the object can steadily rest in the receptacle, the count of joint grasp and task success n(G,T) on the contact points is increased by a fixed interval, for example, one. After all grasps are verified, for each point on the object point cloud, its task relevance can be computed as P(T|G)=n(G,T)/n(G).

To perform instance segmentation during training, the system can use the Sparse 3D U-Net due to its memory efficiency. The network takes as input the entire scene point cloud voxelized into sparse volumes and predicts per point offset with respect to predicted object centers. The training loss can be designed as the L₂ loss between the predicted and the ground-truth offsets. The network is trained independently, since joint end-to-end training with the following networks has been observed to cause instability during training. For example, during testing, the predicted offset is applied to the original points, leading the shifted point cloud to condensed point groups P+P_{offset}. Next, DBSCAN is employed to cluster the shifted points into instance segments. Additionally, the segmented point cloud is backprojected onto the depth image I_{D} to form 2D segments. This approach provides an approximation of the per-object visibility by counting the number of pixels in each segment. Guided by this, the remaining modules of the framework prioritize the top layer of objects given their highest visibility in the pile during grasp candidate generation.

The system generates one or more category-level grasping areas for the canonical representation (450). In other words, the system aggregates the results of all the grasping trials to determine which areas on the canonical representation should be used for grasping for downstream tasks. To do so, the system can transform each of the grasping area heatmaps P(T|G) to the canonical model. The task-relevant grasping area heatmaps over all training instances can then be aggregated and averaged to be the final canonical model's task relevance grasping area heatmap. During testing, due to the partial view of the object's segment, the antipodal contact points pc are identified between the gripper mesh and the transformed canonical model. For each grasp candidate, the score is computed according to:

$${P}_{G} ( T \vert G ) = \frac{1}{\vert {p}_{c} \vert} {\sum }_{{p}_{c}} {P}_{{p}_{c}} ( T \vert G ) .$$

This score can then be combined with the predicted P_{G}(G) from Grasping Q Net to compute the grasp's task-relevance score:

P_{G}(T,G)=P_{G}(T|G)P_{G}(G).

The highest success probability grasp can then be selected and used as the category-level grasping area.

After generating the task-specific, category-level grasping areas, the system can apply them to a newly seen instance of an object to perform the task. For example, the system can determine a correspondence between the new object and the canonical representation to generate task-specific, instance-specific grasping areas on the object. As mentioned previously, if the object is a nut and the downstream task is connector fastening, the task-specific, instance-specific grasping areas might be the sides of the nut. On the other hand, if the task is pick and place, the grasping area might be inside the hole of the nut.

The system can then use these task-specific, instance-specific grasping areas to cause a physical robot to perform the task by manipulating the physical object. In other words, the system can cause a manipulator or an end effector of the robot to make contact with the object at one or more of the specified task-specific, instance-specific grasping areas. And, as described above, the physical robot can automatically perform the downstream task without requiring any adaptation training, even when the new object was never observed during the training process.

Additional details of learning task-specific, category level grasping areas are described in Bowen Wen et al., CaTGrasp: Learning Category-Level Task-Relevant Grasping in Clutter from Simulation, published in the proceedings of the IEEE International Conference on Robotics and Automation (ICRA) 2022, which is herein incorporated by reference. Additional techniques for generating suitable category-level representations are described in commonly owned U.S. Patent No. 63/304,533, entitled “Category-Level Manipulation from Visual Demonstration,” filed on Jan. 28, 2022, which is herein incorporated by reference.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer-implemented method comprising:
obtaining a collection of object models for a plurality of different types of objects belonging to a same object category;
generating a canonical representation for objects belonging to the object category;
performing a plurality of downstream tasks using a plurality of different robot grasps on instances of objects belonging to the category and evaluating each grasp according to success or failure of the downstream task; and
generating one or more category-level grasping areas for the canonical representation for objects belonging to the object category including aggregating the evaluations of grasps according to the downstream task.

2. The method of claim 1, wherein performing the plurality of downstream tasks comprises performing a plurality of simulations of a robot performing the downstream tasks using the plurality of different robot grasps.

3. The method of claim 1, further comprising:
receiving a new object belonging to the object category;
determining a correspondence between the new object and the canonical representation to generate instance-specific stable grasping areas on the object.

4. The method of claim 3, further comprising causing a robot to grasp the new object including making contact between an end effector of the robot and the generated instance-specific grasping areas.

5. The method of claim 4, wherein causing the robot to grasp the new object does not require an adaptation process.

6. The method of claim 4, wherein the new object was not observed during the process for generating grasping areas for the canonical representation.

7. The method of claim 1, wherein the object models are CAD models obtained from publicly available sources.

8. The method of claim 1, where the grasping areas also measure the compatibility with a downstream task.

9. The method of claim 1, wherein the downstream task is connector insertion.

10. The method of claim 1, wherein the downstream task is fastener connection.

11. A system comprising:
one or more computers and one or more storage devices storing instructions that are operable, when executed by the one or more computers, to cause the one or more computers to perform operations comprising;
obtaining a collection of object models for a plurality of different types of objects belonging to a same object category;
generating a canonical representation for objects belonging to the object category;
performing a plurality of downstream tasks using a plurality of different robot grasps on instances of objects belonging to the category and evaluating each grasp according to success or failure of the downstream task; and
generating one or more category-level grasping areas for the canonical representation for objects belonging to the object category including aggregating the evaluations of grasps according to the downstream task.

12. The system of claim 11, wherein performing the plurality of downstream tasks comprises performing a plurality of simulations of a robot performing the downstream tasks using the plurality of different robot grasps.

13. The system of claim 11, wherein the operations further comprise:
receiving a new object belonging to the object category;
determining a correspondence between the new object and the canonical representation to generate instance-specific stable grasping areas on the object.

14. The system of claim 13, wherein the operations further comprise causing a robot to grasp the new object including making contact between an end effector of the robot and the generated instance-specific grasping areas.

15. The system of claim 14, wherein causing the robot to grasp the new object does not require an adaptation process.

16. The system of claim 14, wherein the new object was not observed during the process for generating grasping areas for the canonical representation.

17. The system of claim 11, wherein the object models are CAD models obtained from publicly available sources.

18. The system of claim 11, where the grasping areas also measure the compatibility with a downstream task.

19. The system of claim 11, wherein the downstream task is connector insertion.

20. The system of claim 11, wherein the downstream task is fastener connection.

21. One or more non-transitory computer storage media encoded with computer program instructions that when executed by one or more computers cause the one or more computers to perform operations comprising:
obtaining a collection of object models for a plurality of different types of objects belonging to a same object category;
generating a canonical representation for objects belonging to the object category;
performing a plurality of downstream tasks using a plurality of different robot grasps on instances of objects belonging to the category and evaluating each grasp according to success or failure of the downstream task; and
generating one or more category-level grasping areas for the canonical representation for objects belonging to the object category including aggregating the evaluations of grasps according to the downstream task.
